(19) United States
(12) Patent Application Publication
(10) Pub. No.: US 2025/0111230 A1
(43) Pub. Date: Apr. 3, 2025

(54) SYSTEMS AND METHODS FOR DEEP LEARNING MODEL OPTIMIZATION

(71) Applicant: Themis AI, Inc., Cambridge, MA (US)

(72) Inventors: Daniela Rus, Weston, MA (US); Iaroslav Elistratov, Alanya (TR); Fynn Schmitt-Ulms, Cambridge, MA (US); Ege Demir, Bursa (TR); Alejandro Perez, Manchester, NH (US); Elaheh Ahmadi, Encino, CA (US)

(21) Appl. No.: 18/902,335

(22) Filed: Sep. 30, 2024

Related U.S. Application Data
(60) Provisional application No. 63/586,188, filed on Sep. 28, 2023.

(51) Int. Cl. G06N 3/08; G06N 3/042

(52) U.S. Cl. CPC G06N 3/08; G06N 3/042

(57) ABSTRACT

Methods for optimizing a user model are disclosed. In at least some instances, the methods include receiving a user model and then identifying one or more sub-optimal combinations of operations in the user model. The methods further include generating a modification (e.g., an optimal subgraph) for at least one identified sub-optimal combination of operations in the user model and replacing that identified sub-optimal combination of operations with the generated modification for that identified sub-optimal combination of operations. Still further, the method includes returning the user model with the generated modification as a transformed model. Other methods, and systems for performing any methods disclosed, are also provided.

### RELATED APPLICATION

The present disclosure claims priority to U.S. Provisional Patent Application No. 63/586,188, entitled “Systems and Methods for Deep Learning Model Optimization,” which was filed on Sep. 28, 2023, and which is incorporated by reference herein in its entirety.

### TECHNICAL FIELD

This disclosure generally describes devices, systems, and methods related to computer-automated techniques and algorithms for identifying and solving optimization bottlenecks in machine learning model architectures and deep learning (DL) frameworks.

### BACKGROUND

DL frameworks can provide sets of abstractions which may be composed in a variety of ways (e.g., output of one abstraction may be fed to another). The abstractions may represent individual mathematical operations. The abstractions may also include layers (e.g., a higher level abstraction), where each layer contains one or more operations. A model, such as a DL model, can be a composition of these abstractions. The model may be sub-optimal, such as in scenarios in which an engineer creates a subgraph of operations that unintentionally causes optimization problems to the rest of the model.

Some existing DL libraries may identify errors only in extreme scenarios, such as if the model's activation becomes not a number (NaN) or infinity or if the model's graph (or other model intermediate representation (IR)) is malformed and thus the model cannot be executed all-together. However, these and similar tools may not account for more subtle bugs that do not raise to the level of severity mentioned above (do not cause, e.g., malformed graphs, or exploding gradients/activations) but are still undesirable, causing sub-optimal performance and unpleasant debugging experience. Thus, these bugs are able to silently persist in engineer(s)'s models. Other tools like weight histograms (where a mean and standard deviation of every weight during training is visualized as a distribution to examine changing activation patterns, or lack thereof, at specific layers in a neural network (NN), over time) may not identify underlying causes for observed distributions, or even whether or not the observed distributions are desirable. Such tools also may not remedy the above-mentioned problems.

Accordingly, existing techniques may not identify more subtle issues in the model that may nevertheless cause issues with model performance, model accuracy, and/or model debugging. The DL libraries can provide sets of abstractions (e.g., operations) for a relevant user to manipulate and almost unlimited freedom to compose them. There may be relatively loose constraints on how to combine these operations (e.g., DL frameworks ensure suitable shapes and number of inputs and their types). A set of all possible combinations of these operations may be larger than a set of optimal combinations of these operations. This ultimately can cause relevant users of DL frameworks, such as engineers, to unintentionally impede optimization of their models and/or degrade model's performance by composing the operations in sub-optimal ways.

Some combinations of abstractions provided by the DL libraries are possible (executable) but are sub-optimal. For example, some NN architectures may not have inductive priors suitable for the task and/or an amount of data at hand, while other architectures may transform data in a way that silently impedes learning/optimization. Unlike other bugs in traditional programs, such “optimization bottlenecks” do not cause explicit errors being raised; they may silently persist in DL models, causing downstream sub-optimal performance and an unpleasant debugging experience. Accordingly, there is a need for techniques that automatically detect and address sub-optimal conditions in models such as DL models.

### SUMMARY

The disclosure generally describes technology for automatically identifying and addressing sub-optimal conditions (e.g., bottlenecks such as transformations of data within a model that may impede on learning) in a variety of models, including but not limited to DL models and neural networks (NNs). The disclosed technology can provide automated techniques for identifying representation and other optimization bottlenecks in a given model and mapping those to their optimal counterparts. For example, a computer-automated algorithm can convert a model into an IR, for example a graph of respective mathematical operations (any other IR that is convenient for the task can be analyzed and transformed in the same way, e.g., computational graph, syntax tree, bytecode, etc.). A scoring system may be utilized by the computer-automated algorithm to rank per-operation expressivity inside the model. Resulting score(s) can be integrated into a search system to generate an expressive equivalent for each sub-graph of the model. The sub-graphs of low expressivity can be replaced with their corresponding generated equivalents. The disclosed technology may therefore be used to automatically optimize bottlenecks of the model to improve expressivity of the modified model. The transformed model can be returned to a relevant user such that the relevant user can plug the existing, modified model back into their pipeline for runtime execution without additional modifications or changes to the model or the pipeline.

One embodiment of a method for optimizing a user model includes receiving a user model, identifying one or more sub-optimal combinations of operations in the user model, and generating an optimal replacement for at least one identified sub-optimal combination of operations of the one or more sub-optimal combinations of operations. The method further includes replacing the at least one identified sub-optimal combination of operations in the user model with the respective generated optimal replacement for the at least one identified sub-optimal combination of operations, and returning the user model with each of the respective generated optimal replacements as a transformed model.

In at least some embodiments, identifying the one or more sub-optimal combinations of operations in the user model can include applying a learned neural network (NN) to the user model. The learned NN can have been trained in a process that includes collecting intermediate representations (IRs) of deep learning (DL) models achieving a high performance for learning tasks as ground truth labels and perturbing each IR for the collected models to generate an input. The process of having been trained can have further included training the NN based on the ground truth labels and/or the input to: (i) map the input into an embedding space; (ii) reconstruct the embedding space; and (iii) penalize a difference of the reconstruction with the ground truth labels.

The optimal replacement can include an optimal subgraph and/or an intermediate representation (IR). In at least some embodiments in which the optimal replacement includes a subgraph, the learned NN model can be trained to generate output that can include a label value for each node or subgraph combination of the user model, with the label value indicating whether each node or subgraph combination of the user model is optimal or sub-optimal.

The action of identifying the one or more sub-optimal combinations of operations in the user model can include applying a heuristics-based algorithm to the user model. In at least some such embodiments, the heuristics-based algorithm can be programmed to: (i) input an intermediate representation (IR) representing the user model with model parameters and other metadata; and (ii) produce an expressivity estimate that is correlated with performance of the user model for each node in the IR. Further, the expressivity estimate can be used to identify the one or more sub-optimal combinations of operations in the user model and optimal combinations of operations in the user model.

In at least some embodiments, the action of generating the optimal replacement for at least one of the identified sub-optimal combinations of operations can include providing the identified one or more sub-optimal combinations of operations as inputs to a learned generative NN. Alternatively, or additionally, the action of generating the optimal replacement for at least one of the identified sub-optimal combinations of operations can include conditioning the generation on the user model. This can include, for example preserving original information and data associated with the user model while replacing the identified one or more sub-optimal combinations of operations with the respective generated optimal replacement. By way of further example, this can include using an intermediate representation (IR) of the user model as input to a generative model that is trained to generate optimal replacements for the user model.

The action of identifying the one or more sub-optimal combinations of operations in the user model can include applying a learned NN to the user model. The learned NN can have been trained in a process that includes collecting intermediate representations (IRs) of deep learning (DL) models achieving a high performance for learning tasks to generate ground truth labels, perturbing each IR for the collected models to generate an input, and annotating nodes of each IR. The annotating can be done, for example, based on adding labels indicating suboptimal node organization for each node and edge resulting from adding the perturbation, and/or adding labels indicating optimal organization of nodes to remaining nodes of the IR. Further, the method can include training the NN based on the ground truth labels and/or the input to predict the ground truth labels for each node in the IR given the input.

In at least some embodiments, in response to receiving the user model, the method can include constructing an IR of the user model. Further, the sub-optimal combinations of operations can be identified in the IR of the user model. The action of replacing the identified suboptimal combination of operations with the generated respective optimal replacement can include iterating over nodes in the user model to remove and replace the identified one or more sub-optimal combinations of operations. In at least some embodiments, the method can include generating and returning recommendations to modify at least one of the identified one or more sub-optimal combinations of operations in the user model.

One embodiment of a system for optimizing a user model includes a computer system that comprises one or more processors and memory storing instructions that, when executed by the one or more processors, cause the one or more processors to perform a process. The process includes receiving a user model, identifying one or more sub-optimal combinations of operations in the user model, and generating a modification for at least one identified sub-optimal combinations of operations. The process further includes replacing the at least one identified sub-optimal combinations of operations in the user model with the generated modification and returning the user model with the generated modification as a transformed model.

Identifying the one or more sub-optimal combinations of operations in the user model can include applying a learned neural network (NN) to the user model. The learned NN can have been trained in a process that includes receiving a training dataset of known machine learning models for a particular task or domain, extracting ground truth labels from the training dataset, and annotating node and combinations of operations for the known machine learning models as optimal training the learned NN. The annotating can be based on the ground truth labels and/or the annotations to predict an estimate for each node or combination of operations of a model indicating whether each node or combination of operations of the model is optimal or sub-optimal.

In at least some embodiments, identifying the one or more sub-optimal combinations of operations in the user model can include applying a learned neural network (NN) to the user model. The learned NN can have been trained in a process that includes collecting intermediate representations (IRs) of deep learning (DL) models that achieve a threshold level of high performance for learning tasks as ground truth labels, perturbing each IR for the collected models to generate an input, and training the NN. The training can have been based on at least one of the ground truth labels or the input to: (i) map the input into an embedding space; (ii) reconstruct the embedding space; and (iii) penalize a difference of the reconstruction with the ground truth labels.

The action of identifying the one or more sub-optimal combinations of operations in the user model can include applying a heuristics-based algorithm to the user model. The heuristics-based algorithm can be programmed to: (i) input an IR representing the user model with model parameters and other metadata; and (ii) produce an expressivity estimate that is correlated with performance of the user model for each node in the IR. The expressivity estimate can be used to identify the one or more sub-optimal combinations of operations in the user model and/or optimal combinations of operations in the user model.

In at least some embodiments, generating the modification for at least one of the identified sub-optimal combinations of operations can include conditioning the generation on the user model. Further, conditioning the generation on the user model can include preserving original information and data associated with the user model while replacing the identified one or more sub-optimal combinations of operations with the generated modification. The generated modification can include an optimal subgraph and/or a modification to an intermediate representation (IR).

The disclosed technology provides one or more of the following advantages. Existing approaches in a neural network (NN) architecture search (NAS) can be tasked with generating a DL model architecture that achieves accuracy on a particular learning task. Conventionally, such approaches can generate an entire architecture from scratch without taking into consideration or being conditioned upon an input model. Such conventional processes are computationally intensive and/or time consuming. The disclosed techniques, on the other hand, provide a technical solution to this technical problem in the form of modifying or otherwise replacing only sub-optimal subgraphs of an existing model without requiring the creation of an entirely new model from scratch. Merely replacing (e.g., modifying) portions of the existing model, instead of generating a new model architecture from scratch using conventional systems and techniques, allows for fewer compute resources, less time, and less processing power to be used in order to optimize the existing model. Because the disclosed techniques can be performed so efficiently, the existing model can be returned to a relevant user in real-time, or near real-time, such that the relevant user can plug the existing, modified model back into their pipeline for runtime execution without additional modifications or changes to the model or the pipeline.

Furthermore, because the disclosed techniques are more local in nature compared to the conventional approaches, the disclosure allows for reuse of the information contained in the original architecture to its advantage instead of discarding it (the additional information being human knowledge encoded in the model architecture). This preserves information encoded in the global organization of the nodes and their types desirable to the relevant user (e.g., inductive priors/invariances for their particular task and/or amount of data at hand, etc.). The disclosed techniques, therefore, allow for modifications to suboptimal subgraphs of the existing model to be conditioned on the model itself, allowing for original information or other metrics associated with the model to be preserved.

### BRIEF DESCRIPTION OF THE DRAWINGS

This disclosure will be more fully understood from the following detailed description, taken in conjunction with the accompany drawings, in which:

FIG. 1 is a conceptual diagram of a system that can be used to identify and optimize sub-optimal combinations of operations in a model;

FIG. 2 is a system diagram of one or more system components that can be used with the disclosed technology;

FIG. 3 is an illustration of the disclosed technology for identifying and solving optimization bottlenecks;

FIG. 4 illustrates histograms of correlations between local linear maps across data in a training dataset before and after applying the disclosed technology;

FIG. 5 is a flowchart of a process for optimizing a model using the techniques described herein;

FIG. 6A is a flowchart of a process for training a model, such as an NN, for end-to-end generation of optimal model architecture from a sub-optimal user model architecture;

FIG. 6B is a flowchart of another process for training a model, such as an NN, to identify sub-optimal combinations of operations in a user model; and

FIG. 7 is an example of a computing device and an example of a mobile computing device that can be used to implement the techniques described here.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Unless otherwise defined, all technical terms used herein have the same meaning as commonly understood by one of ordinary skill in the art to which this disclosure belongs.

The disclosed technology provides for automatically identifying and addressing sub-optimal conditions (e.g., bottlenecks such as transformations of data within a model that may impede on learning) in a variety of models, including but not limited to DL models and NNs. A model can be analyzed using the disclosed technology to identify sub-optimal combinations of operations that can be optimized to improve overall performance and accuracy of the model. For example, sub-graphs representing the sub-optimal combinations of operations can be replaced with their corresponding optimized equivalents. Accordingly, the disclosed technology provides for automatically identifying bottlenecks and signaling to a relevant user about presence of such bottlenecks, and automatically fixing those bottlenecks, in some implementations. The fusion of these two controls (human, autonomy system) results in parallel autonomy, or a paradigm of shared robot-human control, whereby the human can control design of model architecture but the autonomy system can continuously run in the background to prevent that human designed architecture from being sub-optimal (augmented model design).

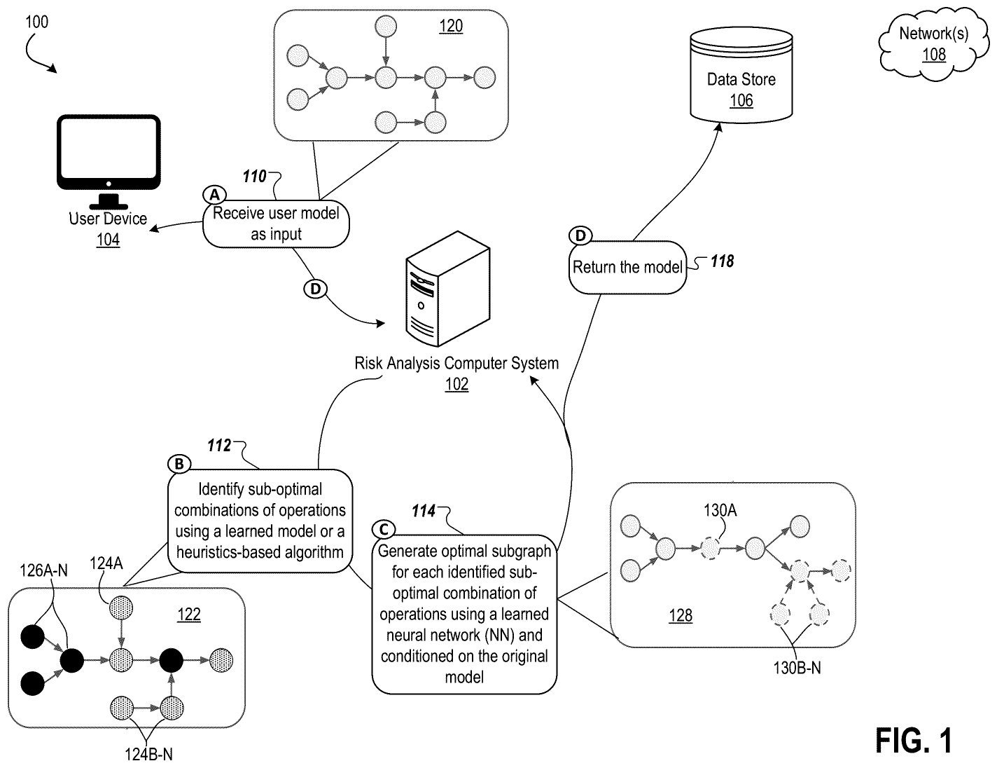

Referring to the figures, FIG. 1 is a conceptual diagram of a system 100 that can be used to identify and optimize sub-optimal combinations of operations in a model. The system 100 can include a risk analysis computer system 102, a user device 104, and a data store 106 in communication (e.g., wired, wirelessly) via network(s) 108. In some implementations, the user device 104 and/or the data store 106 may be part of the computer system 102. Sometimes, one or more of the user device 104 and the data store 106 may be separate systems from the computer system 102 and/or remote from the computer system 102. The computer system 102 can be configured to execute software modules, engines, and/or instructions for performing the disclosed techniques.

In the system 100, the computer system 102 can receive a user model as input from the user device 104 (block A, 110). In some implementations, the computer system 102 can extract the model's representation, such as an IR, which is shown by the graph 120. The representation of the model can be a computational graph, which can include mathematical operations or groups thereof. The mathematical operations can be represented by nodes in the graph 120, and connections between the nodes can be identified as edges. Any other representation of the user model can also be analyzed and transformed similarly as described herein. DL frameworks can use multiple IRs to represent the same user model, which can be done for example at different stages of model compilation and/or execution.

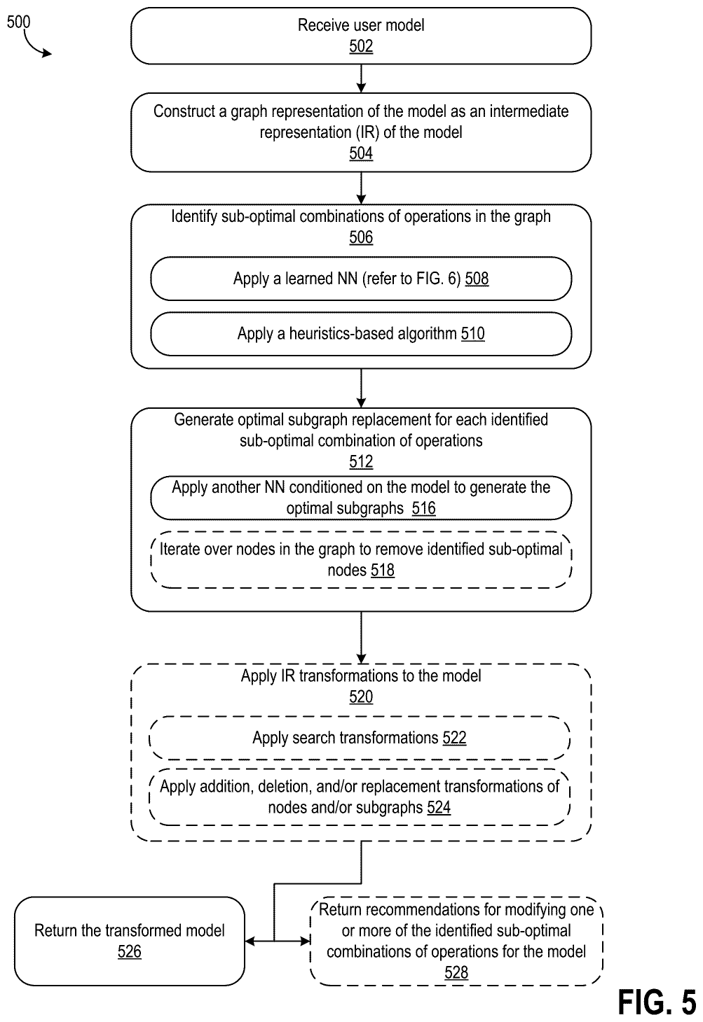

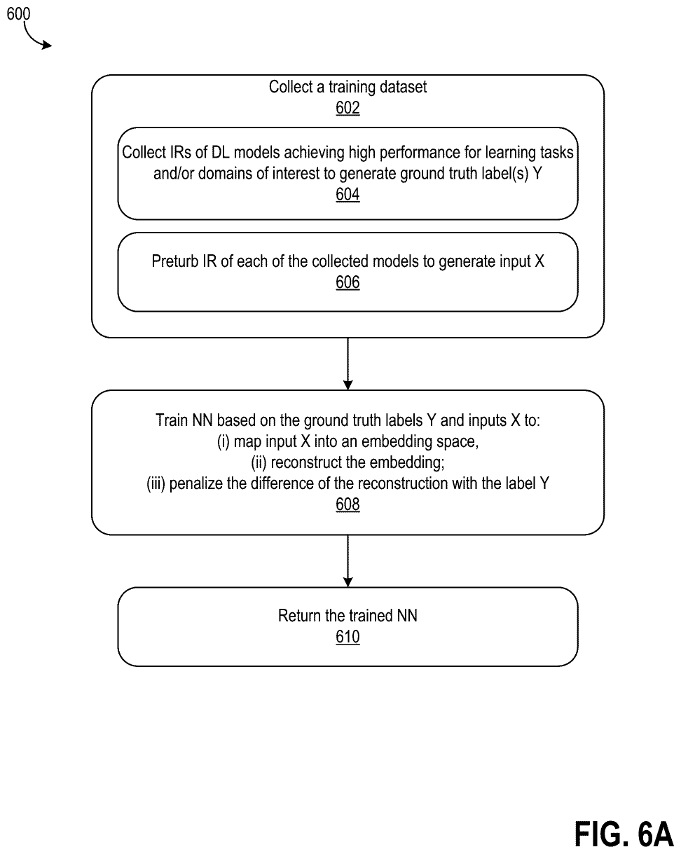

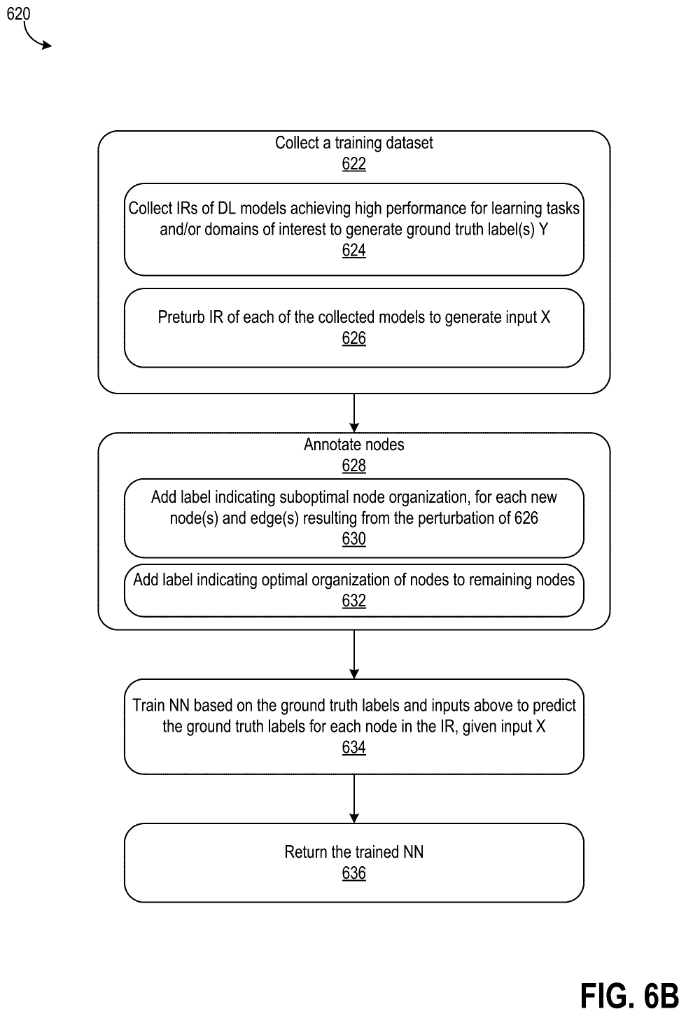

In block B (112), the computer system 102 can identify sub-optimal combinations of operations using a learned model, a heuristics-based algorithm, or a combination thereof, as described further in reference to FIG. 5. In some implementations, an NN model can be used to label nodes in the IR 120 representing the user model as either optimal or sub-optimal, as described further in reference to FIG. 6B. For example, a graph NN can input a computational graph, which represents the user model, perform a node classification task predicting a label for each node, and output those labels—the labels indicating whether each node is optimal or sub-optimal. A combination of the learned model and the heuristics-based algorithm may be used in block B (112).

Updated graph 122 illustrates nodes 124A-N of the user model that have been identified as sub-optimal and nodes 126A-N of the user model as having been identified as optimal. Accordingly, in block B (112), the computer system 102 can identify locations (e.g., nodes, subgraphs) in the IR of the model that may not be optimal (e.g., composed in sub-optimal ways).

The computer system 102 can accordingly generate an optimal subgraph for each, one or more of, or at least one of the identified sub-optimal combinations of operations using a learned NN and conditioned on the original model (block C, 114). There can be multiple ways for formulating operations 112 (B) and/or 114 (C), as described further in reference to FIGS. 6A and 6B. One possible approach, for example, can include formulating the entire task as an end-to-end learning problem, obviating the need for individual operations 112 and/or 114—as described further in reference to FIG. 6A. The task, for example, can be framed as a conditional graph generation problem akin to a de-noising autoencoder in which input X can be mapped into an embedding space and reconstructed back, then a loss function can be applied to penalize a difference of the reconstructed IR with the label Y. Another possible approach is to preserve the individual operations 112 and/or 114 and to frame the problem in operation 112 as a supervised node classification task—as described further in reference to FIG. 6B. The model can be trained, for example, to predict the ground truth labels for each node in the IR given input X. Then, an inference can be performed by replacing X by the IR constructed from the user model. The learned model in block C (114) can be a generative graph NN, in some implementations. An NN can, for example, be used to generate a proposed subgraph conditioned on the IR graph (e.g., the user model that was provided as input in block A, 110). Generating the optimal subgraph can include replacing the respective identified sub-optimal combination of operations, node, and/or subgraph.

Conventional systems may provide a single estimate of expressivity for the entire model. Although based on that estimate it can be possible to replace the model as a whole if its expressivity is below some threshold, instead, it can be assumed that the user model was purposefully designed with user-chosen abstractions in its architecture, thus a global organization of the nodes (and their types) likely encodes some properties desirable to the relevant user (e.g., inductive priors/invariances for their particular task and/or amount of data at hand, etc.). These properties require human knowledge and can be difficult to infer from the expressivity estimate alone, thus replacing the entire model architecture may not preserve these properties. The relevant user encodes this information into the model architecture by the act of creating a model, so it is a valuable piece of information that should not be discarded. Therefore, the architecture of the model remains fixed while the computer system 102 selectively solves local optimization bottlenecks (e.g., subgraphs of nodes with low expressivity inside the graph 122 representing inputted user model). For at least these reasons, a single estimate for the entire model may be too coarse of an estimate to base graph modification instructions on. Thus, instead of having a single global estimate for the entire model, the model's expressivity can be estimated one primitive at a time (e.g., per op/layer) to obtain more granular estimates. This allows for the identification of local optimization bottlenecks inside the model. This can achieve a fusion of human knowledge (encoded in the architecture) with automated identification of the local optimization bottlenecks (parallel autonomy).

To modify the architecture of the model in both blocks C (114) and D (116), the computer system 102 can fix in-place the model architecture except for the sub-graphs of nodes with low expressivity (the identified representation bottlenecks). In other words, the subgraphs of nodes with high expressivity (e.g., the nodes 126A-N in the graph 122) can be fixed in-place and the computer system 102 can automatically replace the subgraphs of nodes with low expressivity (e.g., the nodes 124A-N in the graph 122). Updated graph 128 in FIG. 1 illustrates nodes 130A-N as having been replaced, which were previously identified as having low expressivity in the graph 122. To that end, the computer system 102 can locally apply an architecture search algorithm to generate an optimal sub-graph for each identified low expressivity subgraph in block C (114). The computer system 102 can integrate an expressivity score of each generated local subgraph into the search algorithm, in turn allowing the system to generate an expressive equivalent for every such subgraph. One or more graph editing tools can also be used automatically by the computer system 102 to edit the graph, as shown by the graph 128, representing the model by replacing one or more or at least one of the low expressivity subgraphs (see the nodes 124A-N in the graph 122) with its corresponding generated high-expressivity variant (see the nodes 130A-N in the graph 128). These techniques can solve the identified optimization bottlenecks in a targeted and automated way.

Sometimes, block D, 116, may not be performed. Rather than performing block D, 116, for example, the learned model in block C, 114, can be trained to generate an entire global optimal graph for the model, which would obviate the need to perform block D, 116, thereafter. This is further described at least with respect to FIG. 6A.

The computer system 102 can then return the model (block D, 118) to the user device 104 and/or the data store 106. A relevant user at the user device 104 can further train the returned model (e.g., in the same or similar manner by which they would have trained their original model if transformations had not been done). The relevant user can also plug the existing, modified model back into their pipeline for runtime execution without additional modifications or changes to either the model or the pipeline.

Representation bottlenecks (e.g., transformations of data, inside the user model, which might impede learning) can occur due, at least in part, to how the information is processed inside the model (e.g., what ops are applied on a tensor). The following are merely illustrative examples of representation bottlenecks that can be identified and optimized automatically by the computer system 102 using the disclosed technology.

As an illustrative example, the disclosed technology can be used to identify and optimize the following representation bottleneck: an engineer can add a negative bias to a tensor (e.g., to the result of X@W matrix multiply inside a dense layer), and then feed the output to a rectified linear unit (ReLU). This can cause many entries of the intermediate representation (tensor traveling through the model) to be offset by small negative numbers, causing many activations of the ReLU non-linearity to be zeroed out, and further causing gradient not being propagated to these weights in the backward pass (this is known as “dead ReLU”).

As another illustrative example, the disclosed technology can be used to identify and optimize the following representation bottleneck: a weight initialization strategy should be changed depending on whether or not a model has residual connections. An engineer can add residual connections to a model that previously did not have them without changing the initialization strategy. Due to repeated summation, the activations can spread out to the saturating regimes of nonlinearities, which can lead to the gradient values becoming small and optimization of the model stalling (e.g., depending on the initialization strategy, what ops were applied on the data, types of nonlinearities, number residual connections, etc.).

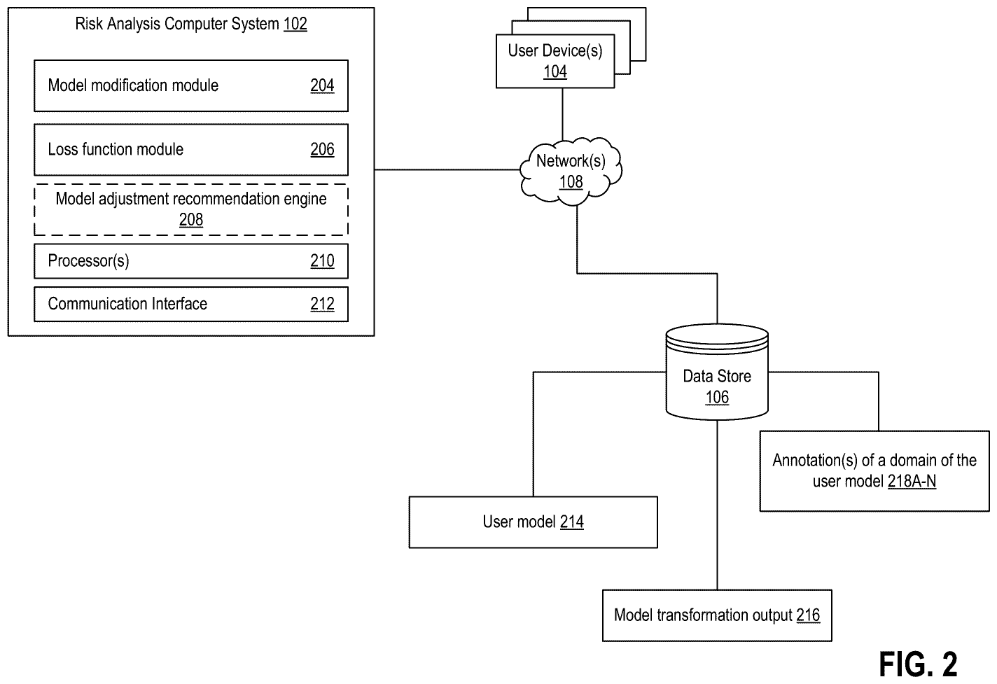

FIG. 2 is a system diagram of one or more system components that can be used with the disclosed technology. The risk analysis computer system 102, the user device(s) 104, and the data store 106 can communicate via the network(s) 108, all of which are described in greater detail above and/or understood by a person skilled in the art in view of the present disclosures, in addition to what is described below.

The computer system 102 can include a model modification module 204, a loss function modification module 206, an optional model adjustment recommendation engine 208, processor(s) 210, and a communication interface 212. The processor(s) 210 can be configured to execute instructions that cause the computer system 102 to perform one or more operations. The one or more operations can include any of the operations and/or processes described herein and/or in reference to the modules 204, 206, and/or 208, among other modules provided for herein or otherwise known to those skilled in the art. The communication interface 212 can be configured to provide communication between the system components described in FIG. 2.

In some implementations, the modules 204, 206, and/or 208 can be software modules that are executed in code at the computer system 102. Sometimes, the modules 204, 206, and/or 208 can be hardware-based components of the computer system 102 that are configured to execute the operations described herein.

In brief, the model modification module 204 can be configured to modify a user model 214, which can be accessed from the data store 106. The user model 214 can be modified using the techniques described herein, such as in reference to at least FIG. 1 and FIG. 5. In some implementations, the model modification module 204 can generate annotations 218A-N of a domain of the user model 214, which can then be stored in the data store 106. The annotations 218A-N can be, for example, labels that identify what field a neural network specializes in and/or what task the neural network is designed to handle. These may include, for instance, discrete categories, such as object detection, image generation, three-dimensional (3D) point cloud segmentation, etc. These annotations 218A-N can be used in blocks 604 and/or 624 of the process 600 as provided for in FIGS. 6A and/or 6B to group model architectures in these categories, at least because typically neural network architectures are specialized for a particular task or set of tasks. Additional details about the annotations are provided for with respect to FIGS. 6A and 6B.

The loss function module 206 can be configured to perform modification to a loss function of the user model 214 and/or any of the other output from the model modification module 204.

The optional model adjustment recommendation engine 208 can be configured to generate one or more recommendations about how to improve the user model 214 according to operations performed and described herein with respect to the user model 214. The engine 208 can provide such recommendations to the user device(s) 104 for selection and/or implementation. In at least some instances, the engine 208 can generate a notification, instruction, alert, message, and/or other output regarding the recommendations to the user device(s) 104. In some implementations, the engine 208 can implement one or more of the recommendations and therefore can automatically adjust the user model 214.

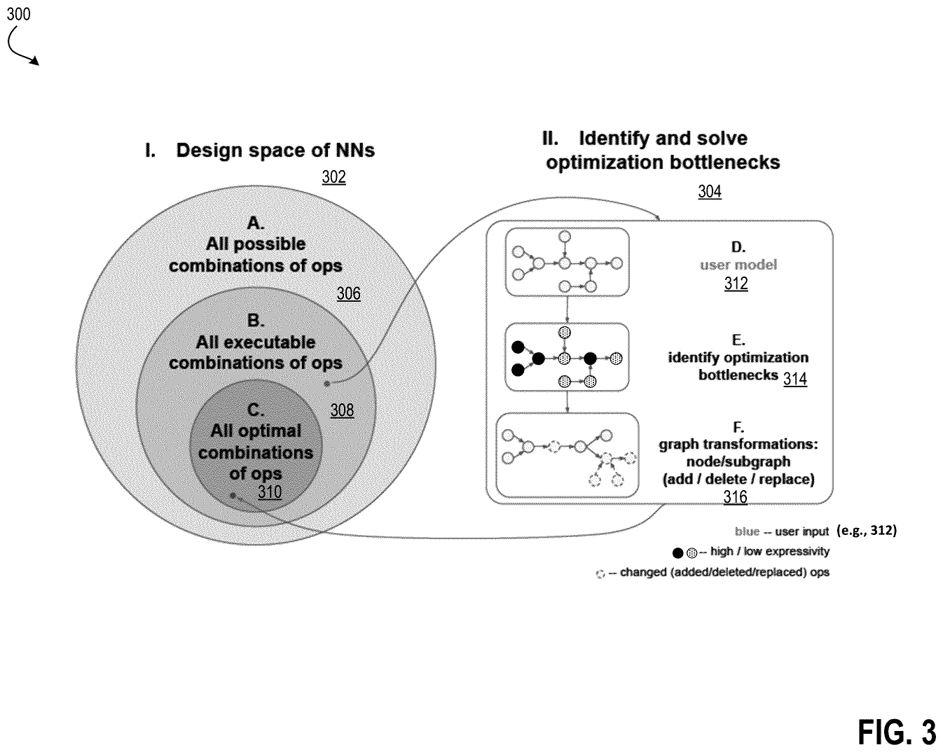

FIG. 3 is an illustration 300 of the disclosed technology for identifying and solving optimization bottlenecks. In the illustration 300, a design space of NNs 302 illustrates all possible combinations of ops (circle 306), all executable combinations of ops (circle 308), and all optimal combinations of ops (circle 310). The design space of NNs 302 can be seen as these three sets A, B, C|C⊂B⊂A. As shown by the all possible combinations of ops (circle 306), the set of all possible NN architectures is large. It can include every combination of all the existing ops and hyperparameters. As shown by the all executable combinations of ops (circle 308), the set of executable architectures is smaller—some architectures in the circle 306 may not run and instead can raise an explicit error at least because their computational graphs may be malformed (e.g., shape mismatches, feeding inputs to an op which does not accept them, etc.). As shown by the all optimal combinations of ops (circle 310), the set of optimal architectures is even smaller—some architectures in the circle 308 may not have inductive priors suitable for the task and/or amount of data at hand, other architectures in the circle 308 may transform data in a way that silently impedes learning/optimization (what we refer to as representation bottlenecks), therefore rendering these architectures sub-optimal.

In the illustration 300, an identify and solve optimization bottlenecks phase 304 can include a representation of a user model as a graph of mathematical operations in 312. A score can be utilized for cheaply ranking per-op expressivity at initialization, thereby allowing to identify subgraphs of low expressivity inside the model in 314. Other methods for estimating per-op expressivity can be used, as described further with reference to block 506. The score can be integrated, for example, into a simple architecture search algorithm allowing to generate expressive equivalent for every such subgraph in 316. In 316, one or more tools can also be used to replace the subgraphs of low expressivity with their corresponding generated equivalents. This approach can be interpreted as a function that (i) identifies executable but sub-optimal implementations (see circles 308 and 310) and (ii) maps those to their optimal counterparts (see circle 310). The direction of arrows shown in the illustration 300 visualizes this approach.

A number of ways of composing abstractions that can produce optimal models may be smaller (see circle 310) than a number of all possible ways of composing the abstractions (see circle 306). The disclosed approach identifies the sub-optimal (but possible) model implementations and fixes (shown by the phases 302 and 304 in combination) them automatically. Accordingly, the illustration 300 shows that there exists a subset of all possible architectures (see circle 306), whose elements work (as in: are executable, graphs are not malformed) but do not work (as in: sub-optimal), specifically shown by the circles 308 and 310.

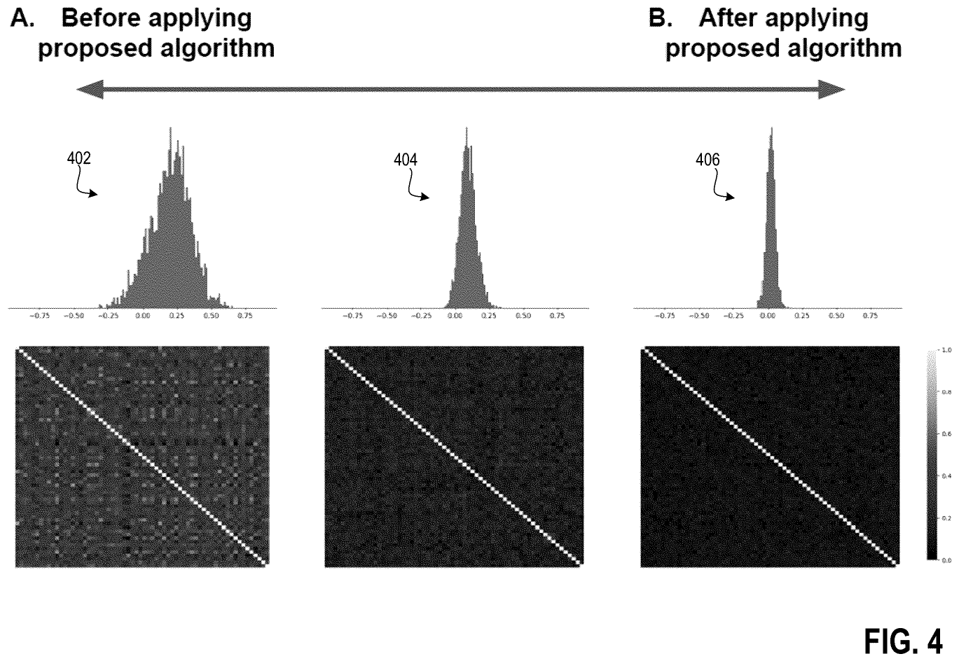

FIG. 4 illustrates an example approach for measuring per-op expressivity (as described further with reference to block 510 in the process 500 of FIG. 5), specifically histograms of correlations 402, 404, and 406 between local linear maps across data in a training dataset before and after applying the disclosed technology. As shown, there is a wider distribution of correlations for the untrained network before applying the proposed algorithm (see the histogram 402), indicating its low expressivity and by extension its poor predicted performance. Conversely, for untrained networks after applying the proposed techniques (see the histogram 406), there is a sharp peak at 0 (the linear maps are largely independent across samples) indicating their high expressivity and by extension their high predicted performance. Applying the disclosed techniques on a sub-optimal model (see the histogram 402) identifies representation bottlenecks and automatically optimizes them to result in a higher expressivity of the modified model (see the histograms 404, 406). The histogram 404 illustrates an in-between stage where some optimization bottlenecks, but not all, have been identified and removed. Accordingly, from left to right, from the histogram 402 to the histogram 404 to the histogram 406, there is a gradual increase in number of optimizations being performed, meaning more optimization bottlenecks are removed at each stage.

FIG. 5 is a flowchart of a process 500 for optimizing a model using the techniques described herein. The process 500 can be performed by the computer system 102 described herein. The process 500 can also be performed by any other suitable computer system, network of computing devices, and/or cloud-based system. For illustrative purposes, the process 500 is described from the perspective of a computer system.

Referring to the process 500 in FIG. 5, the computer system can receive a user model in block 502. The user model can be any type of model. In some implementations, the user model can be a risk-aware variant of an original user model. The risk-aware variant of the model can be generated, for example, by transforming the original user model according to the techniques described in reference to U.S. application Ser. No. 18/478,301, entitled “Systems and Methods for Automated Risk Assessment in Machine Learning,” filed on Sep. 29, 2023, which is incorporated herein in reference in its entirety.

In block 504, the computer-automated algorithm can convert a model into an IR (e.g., a graph of respective mathematical operations). Any other IR that may be convenient for the task can be analyzed and transformed in the same or similar manner (e.g., computational graph, syntax tree, bytecode, etc.).

The computer system can identify one or more or at least one sub-optimal combination(s) of operations in the graph (block 506). In block 506, the computer system can identify sub-optimal combinations of operations using a learned model (block 508) or a heuristics-based algorithm (block 510), or a combination thereof. A heuristics-based algorithm (block 510) can be used, for example, to quantifiably estimate expressivity of a given model, where the expressivity serves as a proxy for the model's ability to represent data, which in turn correlates with model's performance (e.g., correlations between local linear maps, other algorithms that can be used). At least because sub-optimality depends at least on a problem and the amount of data at hand, for example, a sharp reduction in tensor dimensionality before classification and/or regression head, and/or an autoencoder-like architecture may be misclassified by naive algorithms as representation bottlenecks. Therefore, a more expressive algorithm, for example a learned model (block 508), can be used to correctly distinguish the valid use cases. In some implementations, an NN can be used to label nodes in the IR representing the user model as either optimal or sub-optimal. For example, a graph neural network (GNN) can input a computational graph, which represents the user model, perform a node classification task predicting a label for each node, and output those label—the labels indicating whether each node is optimal or sub-optimal, as described further in reference to FIGS. 6A and 6B.

The learned NN can be trained to analyze the entire graph and run a classification task on each node in the graph to determine whether the node is optimal or sub-optimal. For example, the learned NN can perform a binary classification, in some implementations, the output generated by the learned NN can be a label for each node, the label indicating whether or not the node is optimal. Refer to FIGS. 6A and 6B for further discussion about training the learned NN.

Additionally and/or alternatively, as mentioned above, the computer system can apply a heuristics-based algorithm to the IR to identify the sub-optimal combination(s) (block 510) of operations in the IR. The algorithm can use certain features of the graph and/or weights of the user model to estimate the model's expressivity (e.g., capacity of the model to fit a complex function). The algorithm, for example, can be programmed to receive the graph and parameters of the model as inputs, then use these to estimate which subgraph of the graph is optimal versus sub-optimal. The algorithm can, for example, compute correlations between local linear maps across all pairs in a mini-batch of training data. If the correlation is high, then the model may not be as expressive as desired, and limited in its ability to represent a complex function. On the other hand, if the correlation is low, then the model may be identified as more expressive.

In some implementations, the computer system can choose to apply the learned NN of block 508 or the heuristics-based algorithm of block 510. In some implementations, the model 508 can be risk aware, as described further in reference to U.S. application Ser. No. 18/478,301, entitled “Systems and Methods for Automated Risk Assessment in Machine Learning,” filed on Sep. 29, 2023, which is incorporated herein by reference in its entirety. The risk estimates of the learned model (block 508) can be used by the automated system described herein to choose between applying the learned NN of block 508 or the heuristics-based algorithm of block 510. For example, if the output risk of the model of block 508 is high (e.g., when IR of the user model is underrepresented in the dataset that the learned model of block 508 was trained on), the computer system can determine that the heuristics-based algorithm of block 510 should be applied in the process 500. However, if output risk of the model from block 508 is low (e.g., below some threshold), the computer system can determine that the learned NN of block 508 should be applied in the process 500. In some implementations, this determination can be made in real-time, during runtime execution of the process 500. Other criteria besides the risk can also be used in making this determination.

In block 512, the computer system can generate an optimal subgraph replacement for each, one or more of, or at least one of the identified sub-optimal combination(s) of operations. For example, the computer system can apply another learned NN in block 514. This learned NN can be trained to receive the identified sub-optimal combination(s) of operations (e.g., subgraphs) as inputs and generate a re-write of each of those to replace them in the graph of the user model. For example, a GNN or other NN architecture can be trained to generate an optimal subgraph conditioned on the IR representing the user model so that features and information associated with the existing graph (e.g., type of nodes, their global organization, and other information about the graph or user model that is provided by a relevant user who generated/created the user model) remain and are not replaced. As a result, the learned NN can re-write subgraphs rather than generating an entirely new graph to replace the existing graph for the user model.

As another example, the computer system can condition the generation of the optimal subgraphs on the original user model, which was received as input (block 516).

As yet another example, the computer system can optionally iterate over nodes in the IR to remove the identified sub-optimal nodes and replace them with respective optimal subgraph replacements (block 518). Sometimes, the computer system can train the learned NN of block 514 to perform the operations described in reference to block 518. Accordingly, the computer system can automatically fix the sub-optimal combination(s) of operations (e.g., nodes) that were identified and/or labeled by the computer system in blocks 506-510.

Optionally, the computer system may apply one or more IR transformations to the model in block 520 to replace identified subgraphs of sub-optimal operations with corresponding generated subgraphs of optimal operations. To that end, the computer system can optionally apply one or more search, addition, deletion, and/or replacement transformations of nodes and/or subgraphs (block 524).

The computer system can return the transformed model in block 526. The model can be returned to a computing device of the relevant user(s) for runtime use and execution. The model can be stored in a data store for later retrieval and use.

Additionally, or alternatively, the computer system may optionally generate and return recommendations for modifying each, at least one of, or one or more of the identified sub-optimal combinations of operations for the model in block 528. In some implementations, the model described in block 514 can generate output indicating the recommendations for modifying or otherwise re-writing one or more of the subgraphs. Such recommendations can then be returned (e.g. provided, outputted) to computing devices of one or more relevant users. The users may provide user input that causes the computer system to automatically modify and/or re-write the subgraph(s) according to the recommendation(s). In some implementations, the users can provide user input indicating one or more other modifications and/or re-writes for the subgraph(s), which can be automatically executed by the computer system and/or used by the computer system to iteratively train and/or improve the learned NN of at least block 514.

FIGS. 6A and 6B are flowcharts of processes 600 and 620 for training a model, such as an NN, to identify sub-optimal combinations of operations in an original model. More particularly, the process 600 of FIG. 6A can be used for training a model to directly generate an optimal graph(s) for the input model, obviating the need for dividing the process into distinct sequential phases—identifying suboptimal operations (see block 506 of the process 500 in FIG. 5) and generating optimal replacements for such identified operations (see block 512 of the process 500 in FIG. 5). The process 620 of FIG. 6B can be used for training a model to identify sub-optimal combinations of operations in a user model (see block 508 in the process 500 of FIG. 5). The processes 600 and/or 620 can be performed by the computer system 102 described herein. The processes 600 and/or 620 can also be performed by any other suitable computer system, network of computing devices, and/or cloud-based system. For illustrative purposes, the processes 600 and 620 are described from the perspective of a computer system.

In the process 600 of FIG. 6A, a training dataset can be collected and/or generated (block 602). Generating the training dataset can include, but is not limited to automatically extracting data from webpages (e.g., the webpages hosting NN architectures and/or their source code, such as GITHUB, GITLAB, HUGGING FACE, etc.) for top performing model architectures (e.g., above 95^{th} percentile) for each domain and/or learning task of interest (block 604), where IRs for these models can correspond to the ground truth label(s) Y. In at least some implementations, the learning task of interest can be an additional input(s) by a user. For example, the user can provide their user model as well as a description of what task(s) the model is designed to handle. The learning task of interest can then be used, for instance, in blocks 604 and/or 624 to collect model architecture used for this specific domain of interest (e.g., model architectures for point cloud segmentation). Additionally, or alternatively, generating the dataset can further include, but is not limited to, applying a perturbation algorithm to each IR in the ground truth label(s) Y (block 606), where IRs resulting from this operation can correspond to input X. The perturbation algorithm can include randomly replacing operations with other operations, and/or other perturbation algorithms can be used. This procedure can be akin, for example, to negative sampling used in self-supervised learning. In some implementations, generating the training dataset can include annotating the data with labels identifying tasks that a model handles. These tasks can include discrete categories, such as object detection, image generation, three-dimensional (3D) point cloud segmentation, etc. The annotations can be used to group model architectures in the discrete categories.

In some implementations, the computer system can train the model (an NN) on the ground truth labels and inputs described in reference to blocks 602-606 (block 608). The training task can be formulated as an end-to-end learning problem. For example, given the inputs X, an NN can be trained to produce outputs Y (which, in at least some implementations, can obviate the need for performing blocks 506, 512, and 520 in the process 500 of FIG. 5). The task, for example, can be framed as a conditional graph generation problem (similar to a de-noising autoencoder), where input X can be mapped into an embedding space and reconstructed back, then a loss function can be applied to penalize a difference of the reconstructed graph with the label(s) Y. The trained model can then be returned for runtime use in block 610.

In FIG. 6B, the process 620 can be performed to preserve the logic in blocks 506, 512, and 520 of the process 500 of FIG. 5. For example training of the model (NN) in block 508 of the process 500 of FIG. 5 can be formulated as a supervised node classification task.

A training dataset can be collected or otherwise generated in block 622. As described in reference to the process 600 of FIG. 6A, IRs of DL models that achieve a high performance for learning tasks and/or domains of interest can be collected to generate ground truth label(s) Y (block 624). Similar to the process 600 of FIG. 6A, the IR of each collected model can be perturbed to generate input X (block 626).

The computer system can then annotate the nodes in block 628. Specific new nodes and edges that have resulted from perturbation when creating input X can be annotated with label(s) indicating suboptimal node organization (optimization bottlenecks) (block 630). Remaining nodes present before the perturbation can be annotated with a value indicating optimal organization of nodes (block 632).

Then, the problem can be formulated as a node classification task (block 634)—the model described in reference to block 508 of the process 500 of FIG. 5 can be trained to predict the ground truth label(s) Y for each node in the IR given the input X. The inference can be performed by replacing X by the IR constructed from the user model, as described in reference to block 504 in the process 500 of FIG. 5. The trained/learned model (e.g., NN) can be returned in block 636 for runtime use and execution.

Computing System(s) for Use with Present Disclosures.

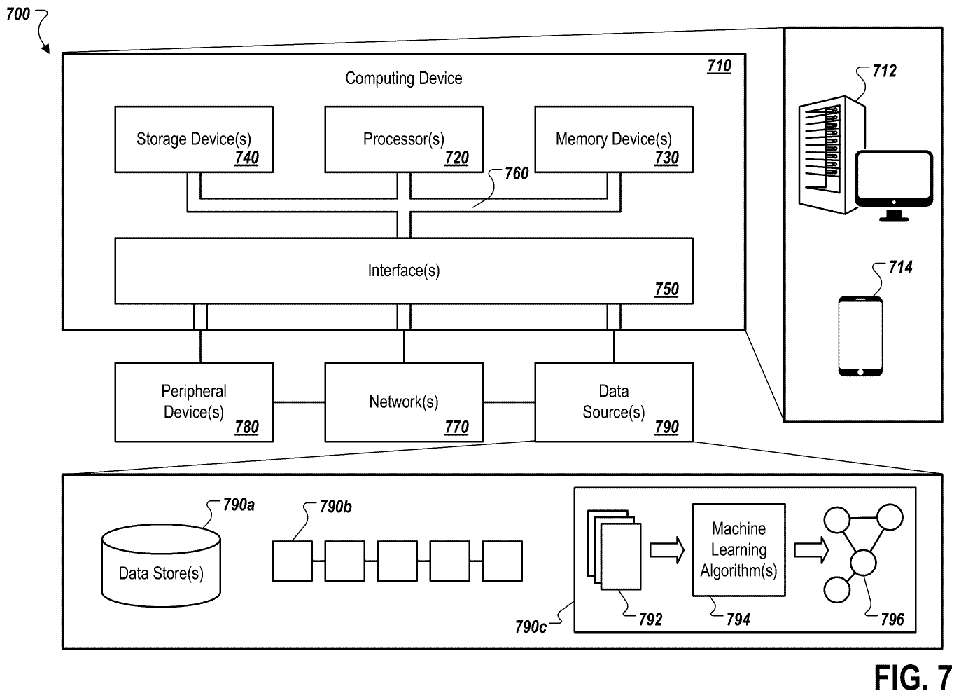

FIG. 7 is a schematic diagram that shows an example of a computing system 700 that can be used to implement the techniques described herein. The computing system 700 includes one or more computing devices (e.g., computing device 710), which can be in wired and/or wireless communication with various peripheral device(s) 780, data source(s) 790, and/or other computing devices (e.g., over network(s) 770). The computing device 710 can represent various forms of stationary computers 712 (e.g., workstations, kiosks, servers, mainframes, edge computing devices, quantum computers, etc.) and mobile computers 714 (e.g., laptops, tablets, mobile phones, personal digital assistants, wearable devices, etc.). In some implementations, the computing device 710 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 710, and an entire system can be made up of multiple devices communicating with each other. For example, the computing device 710 can be part of a computing system that includes a network of computing devices, such as a cloud-based computing system, a computing system in an internal network, or a computing system in another sort of shared network. Processors of the computing device (710) and other computing devices of a computing system can be optimized for different types of operations, secure computing tasks, etc. The components shown herein, and their functions, are meant to be examples, and are not meant to limit implementations of the technology described and/or claimed in this document.

The computing device 710 includes processor(s) 720, memory device(s) 730, storage device(s) 740, and interface(s) 750. Each of the processor(s) 720, the memory device(s) 730, the storage device(s) 740, and the interface(s) 750 are interconnected using a system bus 760. The processor(s) 720 are capable of processing instructions for execution within the computing device 710, and can include one or more single-threaded and/or multi-threaded processors. The processor(s) 720 are capable of processing instructions stored in the memory device(s) 730 and/or on the storage device(s) 740. The memory device(s) 730 can store data within the computing device 710, and can include one or more computer-readable media, volatile memory units, and/or non-volatile memory units. The storage device(s) 740 can provide mass storage for the computing device 710, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 750 can include various communications interfaces (e.g., USB, Near-Field Communication (NFC), Bluetooth, WiFi, Ethernet, wireless Ethernet, etc.) that can be coupled to the network(s) 770, peripheral device(s) 780, and/or data source(s) 790 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 750 can include a control interface that receives commands from an input device (e.g., operated by a user) and converts the commands for submission to the processors 720. The interface(s) 750 can include a display interface that includes circuitry for driving a display to present visual information to a user. The interface(s) 750 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 770 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 710 can communicate with the peripheral device(s) 780, the data source(s) 790, and/or other computing devices over the network(s) 770. In some implementations, the computing device 710 can directly communicate with the peripheral device(s) 780, the data source(s), and/or other computing devices.

The peripheral device(s) 780 can provide input/output operations for the computing device 710. Input devices (e.g., keyboards, pointing devices, touchscreens, microphones, cameras, scanners, sensors, etc.) can provide input to the computing device 710 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 710 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 790 can provide data for use by the computing device 710, and/or can maintain data that has been generated by the computing device 710 and/or other devices (e.g., data collected from sensor devices, data aggregated from various different data repositories, etc.). In some implementations, one or more data sources can be hosted by the computing device 710 (e.g., using the storage device(s) 740). In some implementations, one or more data sources can be hosted by a different computing device. Data can be provided by the data source(s) 790 in response to a request for data from the computing device 710 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 790a. The database(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in the database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 790b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 790c. The machine learning system(s) 790c, for example, can be used to analyze data from various sources (e.g., data provided by the computing device 710, data from the data store(s) 790a, data from the blockchain(s) 790b, and/or data from other data sources), to identify patterns in the data, and to draw inferences from the data patterns. In general, training data 792 can be provided to one or more machine learning algorithms 794, and the machine learning algorithm(s) can generate a machine learning model 796. Execution of the machine learning algorithm(s) can be performed by the computing device 710, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A method for optimizing a user model, the method comprising:
receiving a user model;
identifying one or more sub-optimal combinations of operations in the user model;
generating an optimal replacement for at least one identified sub-optimal combination of operations of the one or more sub-optimal combinations of operations;
replacing the at least one identified sub-optimal combination of operations in the user model with the respective generated optimal replacement for the at least one identified sub-optimal combination of operations; and
returning the user model with each of the respective generated optimal replacements as a transformed model.

2. The method of claim 1, wherein identifying the one or more sub-optimal combinations of operations in the user model comprises applying a learned neural network (NN) to the user model.

3. The method of claim 2, wherein the learned NN was trained in a process that comprises:
collecting intermediate representations (IRs) of deep learning (DL) models achieving a high performance for learning tasks as ground truth labels;
perturbing each IR for the collected models to generate an input; and
training the NN based on at least one of the ground truth labels or the input to:
(i) map the input into an embedding space;
(ii) reconstruct the embedding space; and
(iii) penalize a difference of the reconstruction with the ground truth labels.

4. The method of claim 2,
wherein the optimal replacement comprises a subgraph, and
wherein the learned NN model is trained to generate output comprising a label value for each node or subgraph combination of the user model, the label value indicating whether each node or subgraph combination of the user model is optimal or sub-optimal.

5. The method of claim 1, wherein the optimal replacement comprises an optimal subgraph.

6. (canceled)

7. The method of claim 1, wherein identifying the one or more sub-optimal combinations of operations in the user model comprises applying a heuristics-based algorithm to the user model.

8. The method of claim 7,
wherein the heuristics-based algorithm is programmed to:
(i) input an intermediate representation (IR) representing the user model with model parameters and other metadata; and
(ii) produce an expressivity estimate that is correlated with performance of the user model for each node in the IR, and
wherein the expressivity estimate is used to identify the one or more sub-optimal combinations of operations in the user model and optimal combinations of operations in the user model.

9. The method of claim 1, wherein generating the optimal replacement for at least one of the identified sub-optimal combinations of operations comprises providing the identified one or more sub-optimal combinations of operations as inputs to a learned generative NN.

10. The method of claim 1, wherein generating the optimal replacement for at least one of the identified sub-optimal combinations of operations comprises conditioning the generation on the user model.

11. The method of claim 10, wherein conditioning the generation on the user model comprises preserving original information and data associated with the user model while replacing the identified one or more sub-optimal combinations of operations with the respective generated optimal replacement.

12. The method of claim 10, wherein conditioning the generation on the user model comprises using an intermediate representation (IR) of the user model as input to a generative model that is trained to generate optimal replacements for the user model.

13. The method of claim 1, wherein identifying the one or more sub-optimal combinations of operations in the user model comprises applying a learned NN to the user model, the learned NN being trained in a process that comprises:
collecting intermediate representations (IRs) of deep learning (DL) models achieving a high performance for learning tasks to generate ground truth labels;
perturbing each IR for the collected models to generate an input;
annotating nodes of each IR based on at least one of:
adding labels indicating suboptimal node organization for each node and edge resulting from adding the perturbation; or
adding labels indicating optimal organization of nodes to remaining nodes of the IR; and
training the NN based on at least one of the ground truth labels or the input to predict the ground truth labels for each node in the IR given the input.

14. The method of claim 1,
wherein in response to receiving the user model, the method further comprises constructing an IR of the user model, and
wherein the sub-optimal combinations of operations are identified in the IR of the user model.

15. The method of claim 1, wherein replacing the identified suboptimal combination of operations with the generated respective optimal replacement comprises iterating over nodes in the user model to remove and replace the identified one or more sub-optimal combinations of operations.

16. The method of claim 1, wherein the method further comprises generating and returning recommendations to modify at least one of the identified one or more sub-optimal combinations of operations in the user model.

17. A system for optimizing a user model, the system comprising:
a computer system comprising one or more processors and memory storing instructions that, when executed by the one or more processors, cause the one or more processors to perform a process comprising:
receiving a user model;
identifying one or more sub-optimal combinations of operations in the user model;
generating a modification for at least one identified sub-optimal combinations of operations;
replacing the at least one identified sub-optimal combinations of operations in the user model with the generated modification; and
returning the user model with the generated modification as a transformed model.

18. The system of claim 17, wherein identifying the one or more sub-optimal combinations of operations in the user model comprises applying a learned neural network (NN) to the user model, wherein the learned NN was trained in a process that comprises:
receiving a training dataset of known machine learning models for a particular task or domain;
extracting ground truth labels from the training dataset;
annotating node and combinations of operations for the known machine learning models as optimal training the learned NN based on at least one of the ground truth labels or the annotations to predict an estimate for each node or combination of operations of a model indicating whether each node or combination of operations of the model is optimal or sub-optimal.

19. The system of claim 17, wherein identifying the one or more sub-optimal combinations of operations in the user model comprises applying a learned neural network (NN) to the user model, wherein the learned NN was trained in a process that comprises:
collecting intermediate representations (IRs) of deep learning (DL) models that achieve a threshold level of high performance for learning tasks as ground truth labels;
perturbing each IR for the collected models to generate an input; and
training the NN based on at least one of the ground truth labels or the input to:
(i) map the input into an embedding space;
(ii) reconstruct the embedding space; and
(iii) penalize a difference of the reconstruction with the ground truth labels.

20. The system of claim 17, wherein identifying the one or more sub-optimal combinations of operations in the user model comprises applying a heuristics-based algorithm to the user model.

21. (canceled)

22. The system of claim 17, wherein generating the modification for at least one of the identified sub-optimal combinations of operations comprises conditioning the generation on the user model, wherein conditioning the generation on the user model comprises preserving original information and data associated with the user model while replacing the identified one or more sub-optimal combinations of operations with the generated modification.

23. (canceled)

24. (canceled)
